(19) United States
(12) Patent Application Publication
(10) Pub. No.: US 2008/0066596 A1
(43) Pub. Date: Mar. 20, 2008

(54) Cutting Machine and Method of Moving Cutting Head

(75) Inventors: Yoshihiro Yamaguchi, Ishikawa (JP); Satoshi Ohnishi, Ishikawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KOMATSU INSUSTRIES CORPORATION, KOMATSU-SHI ISHIKAWA JAPAN (JP)

(21) Appl. No.: 11/596,677

(22) PCT Filed: May 20, 2005
(86) PCT No.: PCT/JP05/09234

§ 371 Date: Nov. 16, 2006

(30) Foreign Application Priority Data
May 20, 2004 (JP) 2004-150583

(51) Int. Cl. B26D 5/02; B23K 26/08; B23K 7/10; B26D 1/00; B26D 5/00

(52) U.S. Cl. 83/34; 83/548; 83/58

(57) ABSTRACT

In a thermal cutting machine such as plasma cutting machine or a laser cutting machine, control of the moving speed of a cutting head (24) is improved so as to increase throughput of the cutting machine with increase in cost restricted. Products are cut out one by one from a plate member (14) while a cutting head (24) is moved relative to the plate member (14) on a table (12). In this process, when the cutting head (24) is fast-forwarded without performing cutting to a position at which cutting of each product starts, the speed of movement in the direction (Y-axis direction) along a short side of the table (12) is controlled at a speed higher than that of the movement in the direction (X-axis direction) along a long side of the table. The pattern of a sequence of cutting out the products from the plate member (14) is a meandering pattern in which reciprocation in the Y-axis direction dominates and the movement in the X-direction is one time one way. Exhaust chambers are arranged in the X-axis direction in the table (12), and the exhaust chambers are driven as the cutting head (24) moves in the X-axis direction.

### BACKGROUND OF THE INVENTION

1. Field of the Invention

The present invention relates to a cutting machine that cuts a plate set on a table using a cutting head that moves over the surface of the plate and cuts out a product of a desired shape, and more particularly, to a technology that controls the movement speed of the cutting head in order to improve throughput.

2. Description of the Related Art

As typical examples of the cutting machines of this type there are thermal cutting machines, such as plasma cutting machines that use a plasma torch as the cutting head, laser cutting machines that use laser torches, and gas cutting machines that use gas burners. A movement mechanism improved so as to lighten the machinery that moves the laser torch or the plasma torch in order to simplify cutting speed control and improve cutting accuracy is disclosed in JP-H7-108395-A. Efficiently exhausting fumes generated in the table during cutting by providing a plurality of exhaust chambers in the table, connecting the chambers to a dust collector via exhaust ports equipped with dampers, and shifting the dampers that are opened by the movement of the cutting head is disclosed in JP-2003-136247-A.

Improving the throughput (that is, the quantity of products cut out within a given time period) of a cutting machine of this type is an extremely important issue. As a method of improving throughput, the movement speed of the cutting head is sometimes increased. However, in order to do so, the moving mechanism for the cutting head must be made more powerful and highly rigid. For example, in the case of the moving mechanism described in JP-H7-108395-A, in order to increase the movement speed of a second frame mounting a heavy laser oscillator a considerable increase in power and rigidity is required. In addition, in order to increase the movement speed during cutting (the cutting speed), the power of not only the movement mechanism but also the cutting head itself must be increased. Further, when employing a table having a plurality of exhaust chambers like that described for example in JP-2003-136247-A, if the movement speed of the cutting head is increased the frequency with which the exhaust chamber dampers are opened and closed also increases, and therefore a damper structure capable of high-speed operation must be employed. Given this fact, any attempt to increase the movement speed of the cutting head can lead to a huge increase in the cost of the cutting machine.

### SUMMARY OF THE INVENTION

Therefore, the object of the present invention is to increase the throughput of the cutting machine while holding down increases in the cost of the cutting machine to the extent possible.

The cutting machine according to the present invention comprises a head movement system that moves a cutting head along an X axis and a Y axis of a perpendicular X-Y coordinate system relative to the plate and a controller that controls the head movement system, with the controller controlling the head movement system so that, when moving the cutting head without cutting the plate, movement speed in the Y-axis direction is greater than movement speed in the X-axis direction.

According to the present invention, when moving the cutting head without cutting the plate, the head movement system is operated so that the movement speed in the Y-axis direction is faster than the movement speed in the X-axis direction, thus improving throughput. Preferably, the foregoing X axis and Y axis run along a longer side and a shorter side, respectively, of a rectangular work area on which the plate is placed. In addition, preferably, weight of the portion of the head movement system that moves in the Y-axis direction is lighter than weight of the portion that moves in the X-axis direction. As a result, the cost increase required to make the movement speed in the Y-axis direction faster than the movement speed in the X-axis direction is not that large. Moreover, the movement speed of the cutting head when cutting (the cutting speed) can remain the same as conventionally, which renders the increase in cost required to increase the cutting speed not inevitable.

In a preferred embodiment, the controller, in a case in which multiple products are cut out in succession from the plate on the work area, controls so that a movement speed when moving the cutting head, without cutting, to a position at which cutting of the products starts or from a position at which cutting of the products ends is faster than a movement speed of the cutting head when carrying out cutting of the products.

With such a construction, when cutting out a plurality of products from a single plate, each time the cutting head is moved from the position at which cutting of one product ends to the position at which cutting of the next product begins, the cutting head is moved faster than when the products are being cut. The extent of the improvement in throughput varies depending on the arrangement of the plurality of products on the plate and the setting of the order of cutting out (the nesting). In general, however, nesting in which the pattern of the sequence of the plurality of products in the order of cutting out is a meandering one, proceeding from one end of a short side of the plate to the other end, making a U-turn at the other end and returning from the other end of the short side to the one end, and once again making a U-turn thereat and proceeding toward the short side, is used because it utilizes the plate efficiently and simplifies the work of extracting the product. With this widely used nesting, movement toward the short sides of the table accounts for a large proportion of the total movement of the cutting head. In this case, by increasing the movement speed of the cutting head in the direction of the short sides of the table relative to that in the direction of the long sides, the effect of the improvement in throughput is great.

In a preferred embodiment, the controller adjusts the movement speed of the cutting head according to the thickness and the material of the plate when carrying out cutting, and adjusts the movement speed independently of the thickness and the material of the plate when moving the cutting head without cutting.

According to such a construction, although the movement speed when cutting is set according to such cutting conditions as the thickness and the material of the plate, the movement speed when not carrying out cutting can be set, for example, to the maximum speed of the head cutting device in the Y-axis direction and the maximum speed of the head cutting device in the X-axis direction, without regard to such cutting conditions as the thickness and the material of the plate, thus increasing the throughput improvement effect.

In a preferred embodiment, the head movement system comprises an X-axis moving device that moves in the X-axis direction, a Y-axis boom mounted on the X-axis moving device so as to move together with the X-axis moving device in the X-axis direction and extending in the Y-axis direction, and a Y-axis moving device assembled on the Y-axis boom so as to move in the Y-axis direction and mounting the cutting head.

With the head movement system with such a structure, weight of the portion that moves in the Y-axis direction (that is, the cutting head and the Y-axis moving device) is lighter than weight of the portion of that moves in the X-axis direction (that is, the cutting head, the Y-axis moving device, the Y-axis boom and the X-axis moving device). As a result, in accordance with the principle of the present invention, the movement speed in the Y-axis direction is made to be faster than the movement speed in the X-axis direction, thus enabling throughput to be improved without entailing a large cost increase.

In a preferred embodiment, the cutting machine further comprises [a box-shaped table having on a top surface thereof a rectangular work area on which to place the plate,] a plurality of exhaust chambers aligned in the X-axis direction beneath the work area within the table, an exhaust chamber selection device that selects from the plurality of exhaust chambers one or more exhaust chambers to be exhausted, means that detect a position in the X-axis direction of the cutting head, and means that control the exhaust chamber selection device so that the one or more exhaust chambers to be exhausted shifts as the cutting head moves in the X-axis direction.

With a table having such an exhaust chamber structure, even with the application of the principle of the present invention, in which the movement speed in the Y-axis direction is made faster than the movement speed in the X-axis direction, the frequency with which the selection of the exhaust chambers to be exhausted is switched does not increase dramatically. As a result, applying the principle of the present invention enables throughput to be improved without incurring a large increase in cost.

In a preferred embodiment, the cutting machine further comprises a human body sensor for detecting a person present within a predetermined spatial range of the cutting head. The controller controls the head movement system so as to stop the movement of the cutting head in response to detection of a human body by the human body sensor while moving the cutting head.

According to the present invention, cutting machine throughput can be improved without incurring a large increase in cost.

### BRIEF DESCRIPTION OF THE DRAWINGS

FIG. 1 is a perspective view showing the overall construction of a cutting machine 10 according to the present invention;

FIG. 2 is a plan view showing the internal structure of a table 12;

FIG. 3 is a block diagram showing the structure and functions of a controller 40; FIG. 4 is a flow chart illustrating steps in cutting control (control of the drive and movement of the cutting head) that the controller 40 carries out;

FIG. 5 is a plan view showing a simple example of nesting of products (the arrangement and the order of cutting out of a plurality of products) specified by a cutting program 50;

FIG. 6 is a flow chart illustrating steps in a fast-forward forced stop control using a human body sensor 25 that the controller 40 carries out; and

FIG. 7 is a flow chart illustrating steps in a dust collection routine that the controller 40 and an exhaust control circuit 90 carry out.

### DESCRIPTION OF THE PREFERRED EMBODIMENTS

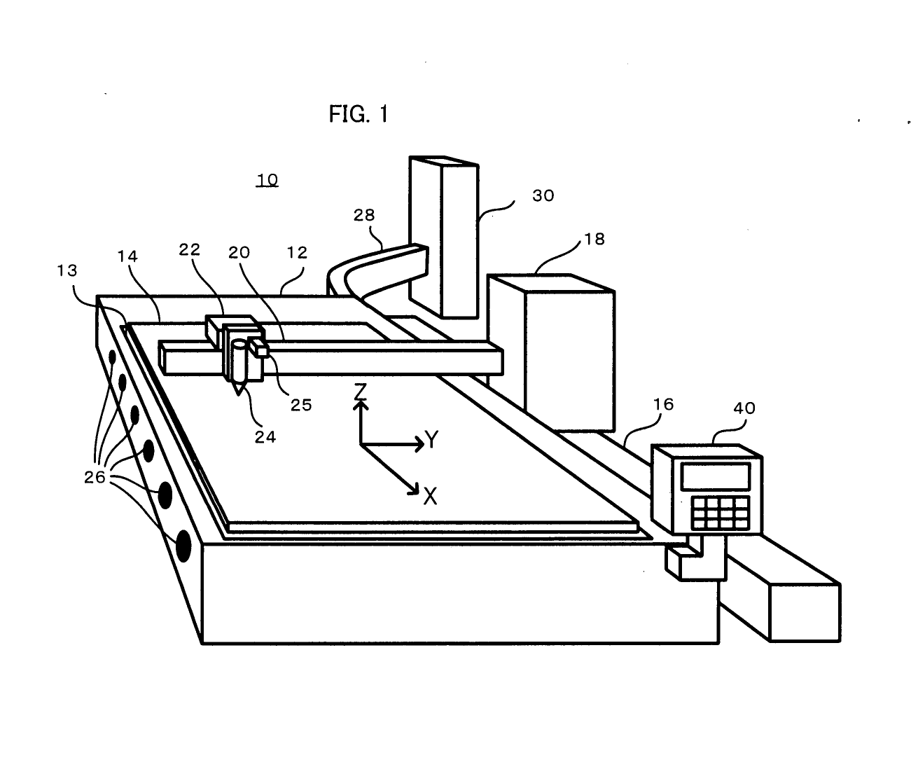

FIG. 1 is a perspective view showing the overall construction of a cutting machine according to the present invention.

As shown in FIG. 1, a cutting machine 10 comprises a box-like table 12 provided on the floor of the machine. A work area 13 is provide on the top surface of the table 12, and on this work area 13 a plate 14 that is the material to be cut is placed. In general, the plate 14 comes in rectangular standard sizes, such as 1.5 m×3 m or 2.4 m×6 m. The table 12 work area 13 is also a rectangular size suited to accommodate the particular standard sizes of the plate, and the table size, too, is a rectangular size that adds to the periphery of the work area 13 exhaust ducts and other such additional portions as are described later.

An X-Y-Z orthogonal coordinate system is defined for numerical calculation processing for the purpose of controlling the cutting position of the plate. The X axis of this X-Y-Z orthogonal coordinate system is parallel to the long sides of the work area 13, the Y axis is parallel to the short sides of the work area 13, and the Z axis is vertical to the surface of the work area 13.

An X-axis track 16 is provided parallel to the long sides of the work area 13 (the X axis), at the bottom of the side of the table. A moving carriage 18 capable of moving in the Y-axis direction along the X-axis track 16 is provided on the X-axis track 16. A Y-axis boom 20 that extends straight out toward the short side of the work area 13 (Y axis) and above the work area 13 is fixedly mounted on the moving carriage 18. When the moving carriage 18 moves in the X-axis direction, the Y-axis boom 20 also moves with it in the X-axis direction. Although in the example shown in the drawing the Y-axis boom 20 is an arm supported by the moving carriage 18 only at one end, this is merely an illustration, and alternatively, the Y-axis boom 20 may be a gantry supported at both ends.

A carriage 22 capable of moving in the Y-axis direction along the Y-axis boom 20 is mounted on the Y-axis boom 20. A cutting head 24 is mounted on the carriage 22. The carriage 22 can move the cutting head 24 in the direction of the Z axis. The cutting head 24 is a plasma torch in the case of a plasma cutting machine for example, a laser torch in the case of a laser cutting machine, a gas burner in the case of a gas cutting machine, or, in the case of a composite-type cutting machine, a set composed of different types of the foregoing torches and burners. The cutting head 24 is driven and controlled by a controller 40 that is described later.

A head movement system for moving the cutting head 24 in the X-, Y- and Z-axis directions is composed of the above-described X-axis track 16, the moving carriage 18, the Y-axis boom 20 and the carriage 22. The head movement system can send the cutting head 24 to any position within the work area 13. The maximum speed with which the head movement system can move the cutting head 24 in the Y-axis direction (that is, the maximum movement speed of the carriage 22) is faster than the maximum speed with which it can move the cutting head 24 in the X-axis direction (that is, the maximum movement speed of the moving carriage 18). Compared to the weight of that portion of the head movement system that moves in the X-axis direction (that is, the X-axis track 16, the moving carriage 18, the Y-axis boom 20, the carriage 22 and the cutting head 24), the weight of that portion of the head movement system that moves in the Y-axis direction (that is, the carriage 22 and the cutting head 24) is much lighter, and therefore it is relatively easy to increase the maximum speed in the Y-axis direction. The head movement system is driven and controlled by the controller 40 that is described later.

A human body sensor 25 is mounted on the carriage 20. The human body sensor 25 is above the work area 13, and is provided in order to detect when a human is present at a position near (that is, with a predetermined distance range of) the above-described head movement system, and in particular the carriage 22 (cutting head 24) which is capable of moving at high speed. A device constructed so as to detect the presence of not only a human body but of any object at a predetermined spatial position, such as an infrared ray sensor, an optical sensor, light barrier or radar that detects an object without contacting it using propagation waves such as infrared rays, light, electromagnetic waves or sound waves, or a tape switch, button switch or the like that reacts to physical contact with an object, can be used as the human body sensor 25. As is described later, when the carriage 22 is moving at high speed in the Y-axis direction and the human body sensor 25 detects the presence of a human in the vicinity, for safety's sake the high-speed movement of the carriage is stopped by the operation of the controller 40 that is described next.

The controller 40 drives and controls the cutting machine 10 in accordance with operating instructions from a human, and in accordance with a cutting program. The functions of the controller 40 are described later.

A plurality of intake fans 26 for sending air currents into the interior space of the table 12 are mounted along a lateral side surface of the table 12 along the Y-axis direction. The interior space of the table 12 is connected to a dust collector 30 through a connecting duct 28. The dust collector 30 sucks air from the interior of the table 12 during cutting of the plate 14, removing fumes and the like contained therein. The intake fans 26 facilitate exhaust from the interior of the table 12 to the dust collector 30.

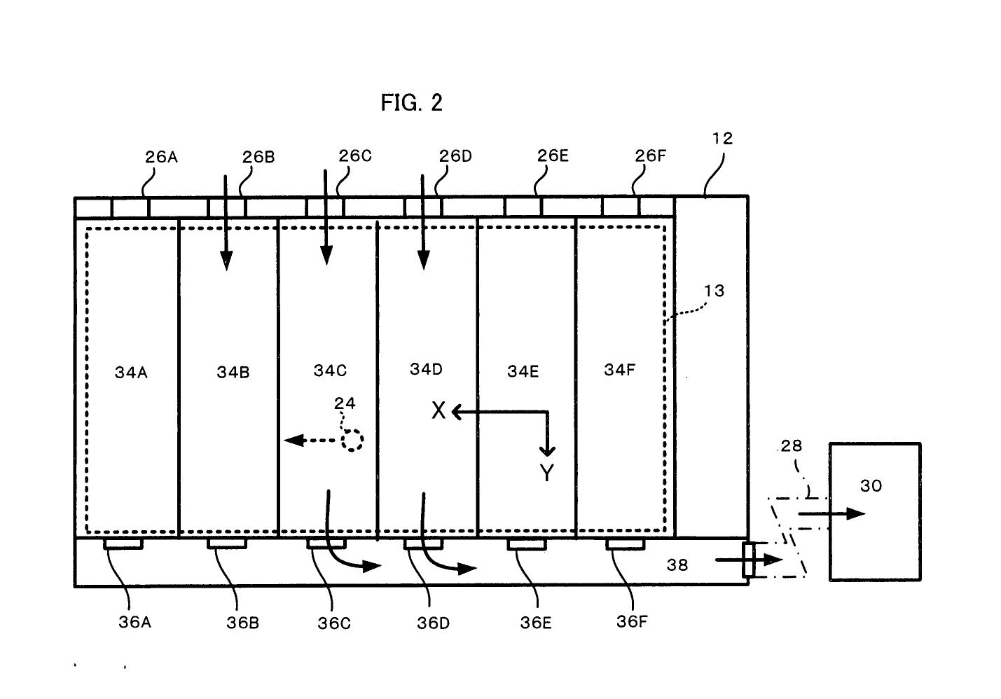

FIG. 2 is a plan view showing the internal structure of the table 12.

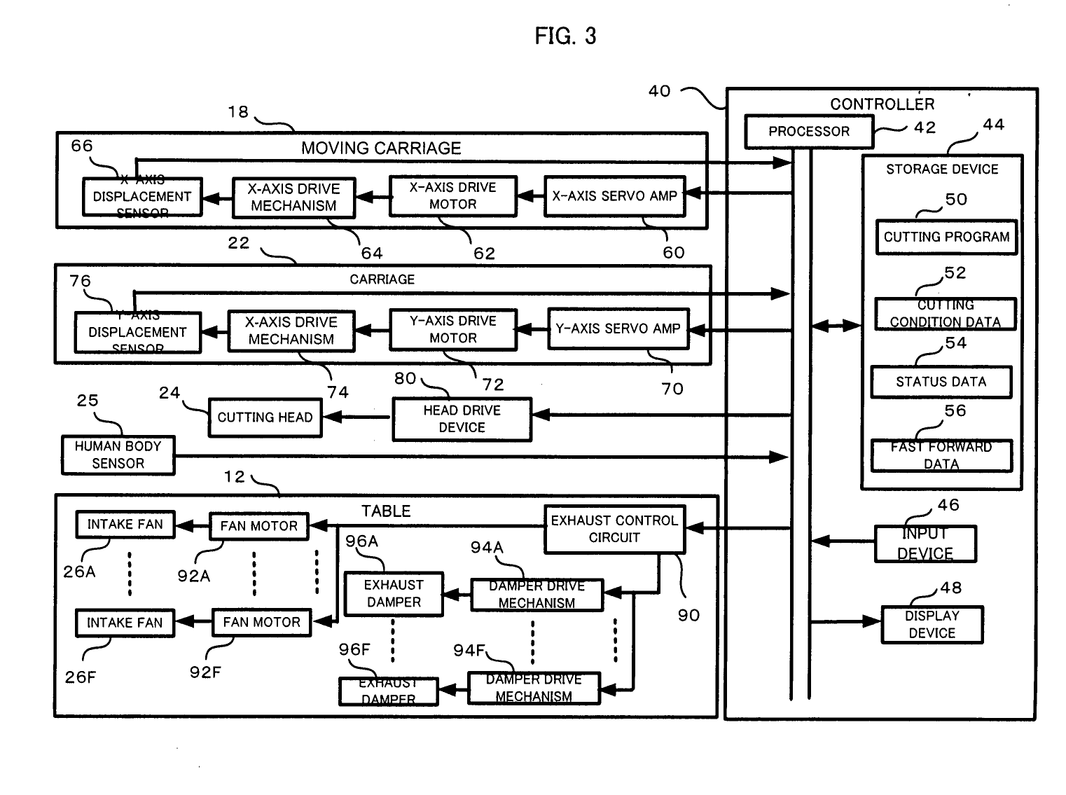

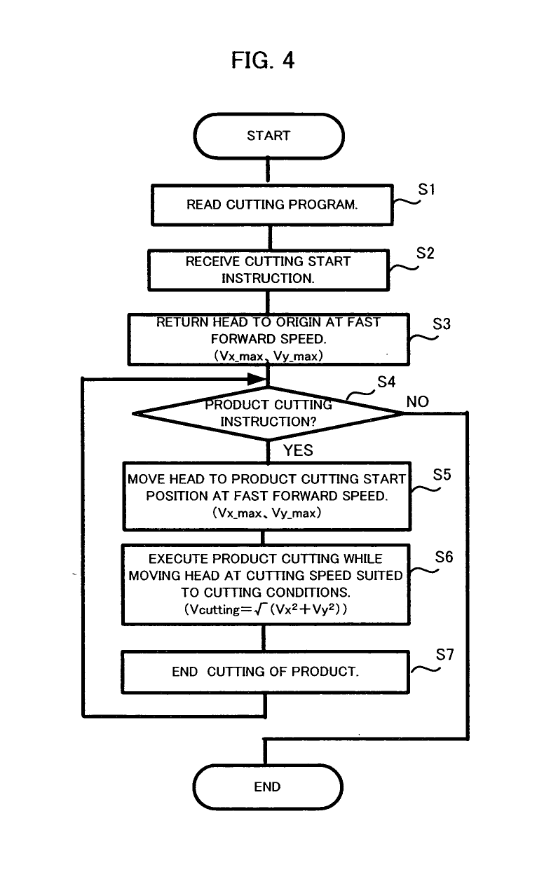

As shown in FIG. 2, inside the table 12 and beneath the work area 13 a plurality of exhaust chambers 34A-34F are aligned and disposed in the direction of the long sides of the work area 13 (the X-axis direction). The exhaust chambers 34A-34F are separated from each other by dividers. Each one of the exhaust chambers 34A-34F extends from one end to the other of the work area 13 in the direction of the short sides of the work area 13 (the Y-axis direction). The exhaust chambers 34A-34F have at one end the above-described intake fans 26A-276F*, respectively, and at the other end exhaust ports 36A-36F. Exhaust dampers (see FIG. 3) 96A-96F are provided on the exhaust ports 36A-36F, respectively. By selectively opening one or more of the exhaust dampers (see FIG. 3) 96A-96F, one or more exhaust chambers to be exhausted are selected from among the exhaust chambers 34A-34F. The exhaust chambers 36A-36F communicate with an exhaust duct 38 inside the table 12. The exhaust duct 38 communicates with the connecting duct 28 and leads to an intake port of the dust collector 30.

As is described later, the intake fans 26A-276F* and the exhaust dampers (see FIG. 3) 96A-96F of the exhaust ports 36A-36F are driven and controlled by the controller 40. The controller 40 detects the position of the cutting head 24 in the X-axis direction (in the direction of the long sides) and controls the opening and closing of the exhaust dampers (see FIG. 3) 96A-96F so as to shift the exhaust chamber(s) to be exhausted as the cutting head 24 moves in the X-axis direction (in the direction of the long sides) according to the position that is detected. Doing so enables dust to be collected efficiently from the inside of the table while keeping the load on the dust collector 30 small.

For example, assume a case in which the current position of the cutting head 24 with respect to a certain exhaust chamber 34C, as indicated by the dotted lines in FIG. 2, is moving from right to left in the diagram as the cutting head 24 moves along the X axis. In this case, the exhaust chamber 34C that corresponds to the position of the cutting head 24 is selected, the exhaust damper of the exhaust port 36C of the exhaust chamber 34C is opened, and further, the intake fan 26C of the exhaust chamber 34C is driven. In addition, the exhaust chamber 34D, which is adjacent to the exhaust chamber 34C and which the cutting head 24 has already passed, also continues to be maintained in a state in which its exhaust port 36D exhaust damper is opened, and further, its intake fan 26D is driven, and continues to be exhausted until a predetermined period of time (that is, a period of time for which fumes are likely still to remain; for example, several seconds) after the passage of the cutting head 24 elapses. Further, at the exhaust chamber 34B, which is adjacent to the exhaust chamber 34C which corresponds to the position of the cutting head 24 and to which the cutting head 24 is likely to move next, although the exhaust damper of the exhaust port 36B is in a closed state the intake fan 26D is still driven. Doing so generates air currents inside the exhaust chamber 34B as preparation for the purpose of being able to start exhausting immediately once the exhaust chamber 34B is selected (incidentally, even when the exhaust damper is closed, air is exhausted from gaps and the like in the plate 14 on top of the exhaust chamber 34B, thus generating air currents). The other, unselected exhaust chambers 34A, 34E and 34F are not exhausted.

FIG. 3 is a block diagram showing the structure and functions of the controller 40.

As shown in FIG. 3, the controller 40 comprises a processor 42, a storage device 44, and input device 46 and a display device 48. The processor 42 carries out a variety of calculation processes for controlling the operation of all parts of the cutting machine 10, and issues control signals based on the calculation results to all parts. In the storage device 44 are stored programs and data that the processor 42 uses, for example, a cutting program 50, cutting condition data 52, status data 54 and fast forward speed data 56 and the like. The input device 46 inputs to the controller 40 a variety of operating instructions starting, with the instruction to start cutting from a human as well as the cutting program 50, the cutting condition data 52, and the like. The display device 48 provides a graphical user interface for the controller 40.

The cutting program 50 describes information about the nesting of the plurality of products that are to be cut out from the plate 14, specifically, the cutting order that specifies carrying out the cutting out of these products according to what sort of product arrangement and in what sort of order.

The cutting condition data 52 describes a variety of possible cutting conditions, for example, the thickness and the material of the various plates 14 that can be used, the rated power of the various cutting heads 24 that can be used (such as the rated plasma electric current value and nozzle diameter in the case of a plasma torch, or the rated laser beam power value in the case of a laser torch) and the like. Desired cutting conditions can be selected from among the variety of cutting conditions in the cutting condition data 52 by instruction from the input device 46.

The status data 54 describes a variety of cutting status data corresponding to each of the variety of possible cutting conditions. Here, the cutting status data is the variety of statuses that are controlled when carrying out cutting, and is composed of multiple pieces of data such as the cutting speed (the speed of movement of the cutting head 24 during cutting) and the cutting head 24 drive status (the plasma electric current value and gas flow in the case of a plasma torch, the laser beam power value in the case of a laser torch, and so forth).

The movement speed in the Y-axis direction and the movement speed in X-axis direction when the cutting head 24 is moved without carrying out cutting is set in the fast forward speed data 56. The movement speed in the Y-axis direction and the movement speed in X-axis direction that are set here are faster than the Y-axis direction component and the X-axis direction component of the cutting speed that is described in the status data 54 described above. As a result, in this specification, the moving of the cutting head 24 without carrying out cutting is called “fast forward” because the movement is faster than the movement speed when cutting (the cutting speed), with the movement speed in the Y-axis direction and the movement speed in the X-axis direction that are set in the fast forward speed data 56 called the “Y-axis fast forward speed” and the “X-axis fast forward speed”, respectively. Here, the Y-axis direction fast forward speed is set to a faster value than the X-axis direction fast forward speed. For example, the Y-axis direction fast forward speed is set to the maximum movement speed of the above-described carriage 22 and the X-axis direction fast forward speed is set to the maximum movement speed of the above-described moving carriage 18.

The processor 42 reads in the cutting program 50, the cutting status data that corresponds to the cutting conditions selected from among the status data 54, and the fast forward speed data 56. In accordance with the order that the cutting program 50 specifies, the processor 42 controls the driving and the movement of the cutting head 24 so as to successively cut out a plurality of products from the plate 14. In the process of carrying out this control, the processor 42, when carrying out cutting out of the products, moves the cutting head 24 at the cutting speed specified by the read-in cutting status data. On the other hand, when fast-forwarding the cutting head 24 to a position at which cutting of the products starts or from a position at which cutting of the products ends, the processor 42 moves the cutting head 24 in the Y-axis direction and in the X-axis direction according to the respective Y-axis direction fast forward speed and the X-axis direction fast forward speed set in the fast forward speed data 56. In addition, the processor 42, while moving the cutting head 24, monitors the output signal from the human body sensor 25, and immediately and forcibly stops the movement of the cutting head 24 when the output signal indicates that a human is present. (This forced stop control may be applied to both movement during cutting and fast-forwarding without cutting, or it may be applied only to fast forwarding.) Moreover, in the process of carrying out the control described above, the processor 42, when cutting out the products, drives the cutting head 24 according to the drive status specified by the read-in cutting status data. Further, in the process of the above-described control, the processor 42 adjusts the dust collection operation (exhaust of) the exhaust chambers (see FIG. 2) 34A-34F depending on the position of the cutting head 24 along the X axis.

To control the movement of the cutting head 24 as described above, the processor 42 outputs to the moving carriage 18 and the carriage 22, respectively, a Y-axis direction speed instruction and an X-axis direction speed instruction. At the moving carriage 18, an X-axis servo amp 60 controls a rotation speed of an X-axis drive motor 62 according to the X-axis direction speed instruction. An X-axis drive mechanism 64 (such as a rack and pinion mechanism or a ball screw mechanism) is driven by the X-axis drive motor 62, moving the moving carriage 18 in the X-axis direction. An X-axis displacement sensor 66 (such as a rotary encoder coupled to the pinion shaft or the ball screw mechanism) detects the displacement of the moving carriage 18 in the X-axis direction. The processor 42, using the detection signal of the X-axis displacement sensor 66 as feedback, calculates the position of the cutting head 24 in the X-axis direction and uses this in the position control calculation of the cutting head 24 in the X-axis direction. At the carriage 22, a Y-axis servo amorphous material portion 70 controls the rotation speed of a Y-axis drive motor 72 according to a Y-axis speed instruction. A Y-axis drive mechanism 74 (such as a rack and pinion mechanism or a ball screw mechanism) is driven by the Y-axis drive motor 72, moving the carriage 22 in the Y-axis direction. A Y-axis displacement sensor 76 (such as a rotary encoder coupled to the pinion shaft or the ball screw mechanism) detects the displacement of the carriage 22 in the Y-axis direction. The processor 42, using the detection signal of the Y-axis displacement sensor 76, calculates the position of the cutting head 24 in the Y-axis direction and uses this in the position control calculation of the cutting head 24 in the Y-axis direction.

To control the driving of the cutting head 24 as described above, the processor 42 outputs a head output signal instruction to a head drive device 80 (such as a plasma power supply and gas supply valve in the case of a plasma cutting machine, or a laser oscillator in the case of a laser cutting machine). The head drive device 80 adjusts the output power of the cutting head 24 according to the head output control instruction.

To control the operation of collecting dust from (exhausting) the exhaust chambers (see FIG. 2) 34A-34F, the processor 42 outputs a head position signal indicating the position of the cutting head 24 in the X-axis direction to an exhaust control circuit 90 (shown inside the table 12 in the example shown in FIG. 3, but which may be incorporated in the controller 40). Based on the head position signal, the exhaust control circuit 90 selects the exhaust fan(s) to be driven from among the plurality of exhaust fans 26A-26F, and also selects the exhaust damper(s) to be opened from among the plurality of exhaust dampers 96A-96F. Then, the exhaust control circuit 90 controls fan motors 92A-92F, rotating only the selected fan(s), and also controls damper drive mechanisms 94A-94F (such as a combination of electromagnetic valves and air cylinders) so as to open only the selected exhaust damper(s).

FIG. 4 is a flow chart illustrating steps in a cutting control (control of the driving and movement of the cutting head 24) that the controller 40 carries out.

As shown in FIG. 4, in step S1, the processor 42 reads in the cutting program 50, the cutting status data that corresponds to the cutting conditions selected from among the status data 54, and the fast forward speed data 56. In step S2, the processor 42 receives a cutting start instruction from the input device 42 and starts execution of the cutting program 50.

When execution of the cutting program is started, first, in step S3, the cutting head 24 is fast-forwarded to the origin of the plate 14 (for example, the upper left corner of the plate 14 shown in FIG. 1. The fast forward speed in the X-axis direction and in the Y-axis direction is set in the fast forward speed data 56, so that, for example, the X-axis direction fast forward speed is the maximum movement speed Vx_max of the moving carriage 18 and the Y-axis direction fast forward speed is the maximum movement speed Vy_max of the carriage 22, with the Y-axis direction fast forward speed Vy_max being faster than the X-axis direction fast forward speed Vx_max. When the cutting head 24 is positioned at the origin of the plate 14, the X,Y coordinate values for head position control in the processor 42 are set to zero. Thereafter, in step S4, a check is made to see if product cutting instructions are described in the cutting program, and if product cutting instructions are described (YES in step S4), the routines of steps S5-S7 are carried out in accordance with those product cutting instructions.

In step S5, the cutting head 24 is fast-forwarded to the cutting start position indicated by the product cutting instructions. As described above, the Y-axis direction fast forward speed Vy_max is faster than the X-axis direction fast forward speed Vx_max.

Thereafter, in step S6, the cutting head 24 is driven and the cutting head 24 is moved along a cutting line that is specified by the product cutting instructions from the cutting start position to the cutting finish position specified by the product cutting instructions, by which the cutting out of a single product is executed. During cutting execution, the X-axis direction movement speed Vx and the Y-axis direction movement speed Vy are controlled so that their combined moving speed √ (Vx²+Vy²) becomes a cutting speed Vcutting specified by the cutting status according to the selected cutting conditions. The cutting speed Vcutting varies depending on the cutting conditions. For example, the thinner the thickness of the plate 14, or the greater the rated power of the cutting head 24, the faster the cutting speed Vcutting. However, under all cutting conditions, the above-described fast forward X-axis direction speed Vx_max and Y-axis direction speed Vy_max is each greater than the cutting speed Vcutting X-axis direction speed component Vx and Y-axis direction speed component Vy.

Thereafter, once cutting to the cutting finish position is completed, in step S7 the driving of the cutting head 24 is stopped, finishing cutting of the product.

Once cutting of one product is finished as described above, the process once more returns to step S4, a check is made to determine whether or not there are product cutting instructions for the next product, and, if there are product cutting instructions, the routines of steps S5-S7 are executed according to those product cutting instructions.

By repeating the routines of steps S4-S7 as described above from the first product to the last product, multiple products are cut out in succession. After the last product is cut out (NO in step S4), execution of the cutting program 50 is terminated.

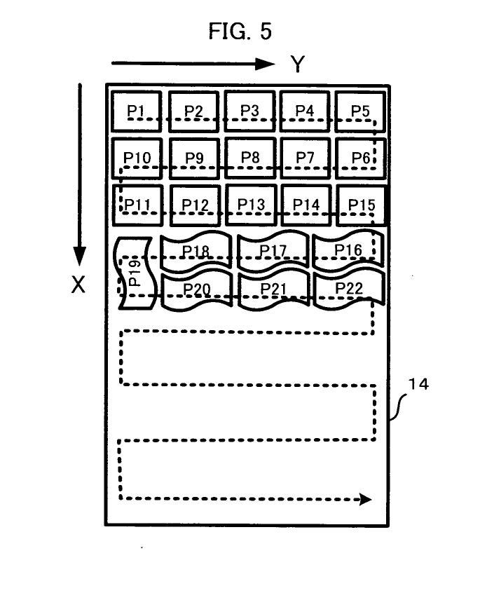

FIG. 5 shows a simple example of the nesting of products (the arrangement and the order of cutting out of a plurality of products on the plate 14) as specified by the cutting program 50.

In general, nesting is automatically calculated by the computer program that creates the cutting program 50 so as to minimize the volume of scrap from the plate 14, and further, to make the fast forward distance (the distance of wasted movement in which there is no cutting) as short as possible. As a pattern of the order of cutting out of multiple products based on a calculated nesting (a pattern of a sequence of a plurality of products according to the cutout order), although many different ones are used, one widely used cutout order pattern is like that shown in FIG. 5.

Specifically, the cutout order pattern shown in FIG. 5, as indicated by the dotted line, is a meandering one, proceeding first from one end of the plate 14 to the other in the direction of the Y axis (the short sides) of the plate 14 (the sequence of from product P1 to P5) and then making a U-turn and returning to the one end from the other in the Y-axis direction (the short sides) of the plate 14 (the sequence of from product P6 to P10), and then once again making a U-turn and proceeding in the Y-axis direction (the short sides) of the plate 14 from the one end to the other end (the sequence of from product P11 to P15).

One reason the cutout order pattern shown in FIG. 5 is widely used is because, once the cutting operation proceeds to a certain stage (such as the stage at which the cutting of P1-P15 is finished), a person can climb onto the table and remove the cut-out products while the operation of cutting the succeeding products is being continued, and therefore the overall cutting operation can be made more efficient. Moreover, when there are not so many products as to use the entire plate 14, the remainder of the plate 14 left after product cutout assumes a rectangular shape that is not badly balanced vertically and horizontally.

With this type of widely used cutout order pattern, the Y-axis direction distance component represents a larger proportion of the total fast forward distance of the cutting head 24 than the X-axis direction distance component. Therefore, making the Y-axis direction fast forward speed Vy_max faster than the X-axis direction fast forward speed Vx_max enables a large reduction in work time. Moreover, adopting a cutout order pattern of nesting in which the proportion of the total fast forward distance occupied by the Y-axis direction distance component is greater than that occupied by the X-axis direction distance component without limitation to the example of FIG. 5 increases the improvement in throughput gained by applying the principle of the present invention.

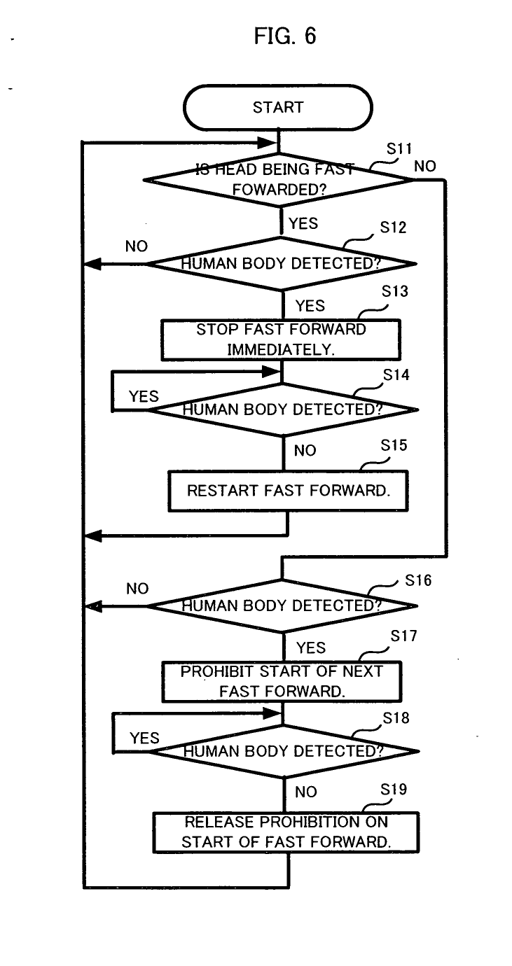

FIG. 6 is a flow chart illustrating steps in a fast-forward forced stop control using a human body sensor 25 that the controller 40 carries out.

As shown in FIG. 6, in step S11, the processor 42 determines whether or not a fast forward is being executed. When the routines of step S3 or step S5 shown in FIG. 4 are being executed, it is determined that a fast forward is being executed. When such a determination is made, the processor 42, in step S12, based on signals form the human body sensor 25, determines whether or not a person is within a predetermined range of the carriage 22 on the table 12. If the results indicate that a person is not present (NO in S12), then the fast forward is continued. However, if it is determined that a person is present (YES in S12), then in step S13 the processor 42 immediately forcibly stops the fast forward. After the fast forward is forcibly stopped, in step S14 the processor 42, based on the signals from the human body sensor 25, determines whether or not the person has left, and if so (NO in S12), resumes the fast forward in step S15.

Moreover, when fast forward is not being executed (such as when a product is being cut out), in step S16 the processor 42 monitors the signals from the human body sensor 25. Then, if it is determined that a person is on the table 12 and within a predetermined range of the carriage 22 (YES in step S16), in step S17 the processor 42 prohibits the start of the fast forward that is to be carried out next. Once the start of fast forward is prohibited during product cutting, the start of fast forward to the cutting start position of the next product is delayed until the prohibition is released, even if the cutting out of the current product is finished. Thereafter, the processor 42, in step S18, determines whether or not the person has left -based on the signals from the human body sensor 25, and if so, in step S19 releases the fast forward prohibition.

With this type of fast-forward forced stop control, contact with the carriage 22 moving at high speed in fast forward is avoided even if a person climbs onto the table 12 to remove a product during cutting. It should be noted that the forced stop control can be applied not only to fast forward but also to movement during cutting. However, since the speed of movement during cutting is slow, and further, the movement distance is within the range of the product size as well, in reality the danger of contact with a person is small. Moreover, with a forced stop of movement when cutting, there is a possibility of damaging the product. Consequently, applying forced stop control only to fast forward fully ensures human safety without adversely affecting the quality of the product.

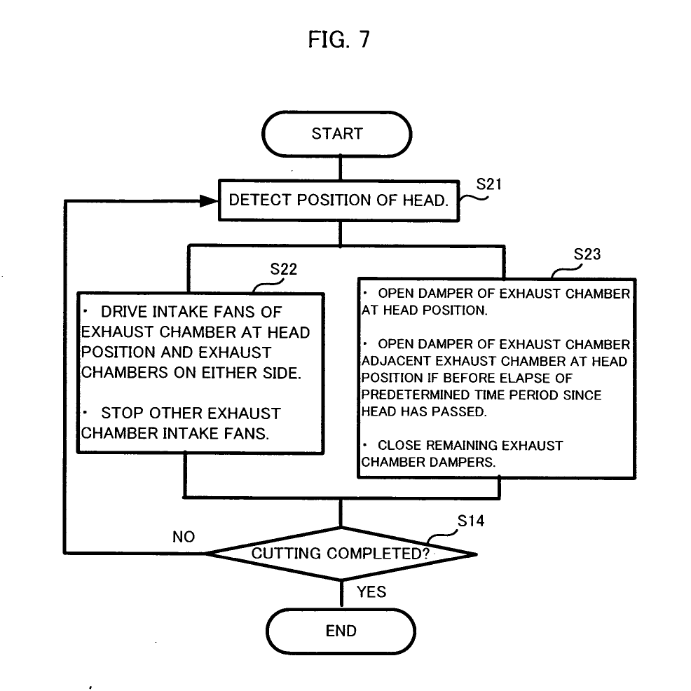

FIG. 7 is a flow chart illustrating steps in a dust collection routine that the controller 40 and the exhaust control circuit 90 carry out.

As shown in FIG. 7, in step S21, the processor 42 calculates the position in the X-axis direction of the cutting head 24 based on signals from the X-axis displacement sensor 66 and reports the calculated position to the exhaust control circuit 90. It should be noted that, for the purpose of dust collection, it is sufficient if the detection of the position of the cutting head 24 in the X-axis direction indicates the position corresponding to which exhaust chamber at which the cutting head 24 is positioned, and therefore, as a detection method, alternatively, instead of using calculations based on signals from the X-axis displacement sensor 66 described above, it is possible to use another technique in which the Y-axis boom 20 or the moving carriage 18 turns on and off limit switches disposed at positions corresponding to each of the exhaust chambers 34A-34B of the table 12.

In step S22 the exhaust control circuit 90 rotates the exhaust fans of the exhaust chamber corresponding to the position of the cutting head 24 and the exhaust chambers on either side thereof, and stops the exhaust fans of the remaining exhaust chambers. In parallel with this, in step S23 the exhaust control circuit 90 opens the exhaust damper of the exhaust chamber corresponding to the position of the cutting head 24, and moreover, of the remaining exhaust chambers keeps open the exhaust damper of that exhaust chamber for which a predetermined period of time (for example several seconds) since the cutting head 24 has passed has not yet elapsed, and closes the exhaust dampers of the other exhaust chambers. With the routines of steps S22 and S23, the exhaust chamber where the cutting head 24 is currently positioned and the exhaust chamber that the cutting head 24 has already passed and in which fumes remain is subjected to dust collection (exhaustion), and moreover, air currents are generated in preparation for dust collection (exhaustion) at the exhaust chamber over which the cutting head 24 will pass.

As long as the cutting operation is being continued (NO in step S14), the routines of steps S21-S23 described above are repeated.

If, when carrying out this type of dust collection, a configuration is adopted in which the cutting head 24 is moved in the X-axis direction from start to finish at high speed in order to improve throughput, the switching on and off of the intake fans 26A-26F, and the opening and closing of the exhaust dampers 96A-96F, are carried out frequently, and therefore the intake fans 26A-26F and the exhaust dampers 96A-96F must be sufficiently rigid and powerful. However, in the construction of the present embodiment, which seeks to improve throughput by making the Y-axis direction fast forward speed Vy_max greater than the X-axis direction fast forward speed Vx_max, the fast forward method does not lead to a further increase in the frequency with which the intake fans 26A-26f are switched on and off and the exhaust dampers 96A-96F opened and closed. Therefore, in the present embodiment, the effect of an improvement in throughput can be obtained without a large increase in the cost of the construction for the purpose of collecting dust. In addition, as noted already, increasing the speed of the lightweight carriage 22 can be achieved at lower cost than increasing the speed of the massive moving carriage 18, and thus the effect of the improvement in throughput can be obtained without a large increase in the cost of the head movement system.

While the present invention has been described with reference to the foregoing preferred embodiments, it is to be understood that these preferred embodiments are merely illustrative of the present invention and that the scope of the present invention is not limited thereto. Consequently, it is to be understood that the present invention encompasses all the various other embodiments by which the invention can be implemented.

1. A cutting machine comprising:
a head movement system that moves a cutting head along an X axis and a Y axis of a perpendicular X-Y coordinate system relative to a plate; and
a controller that controls said head movement system,
the controller controlling said head movement system so that, when moving said cutting head without cutting said plate, movement speed in the Y axis direction is faster than movement speed in the X axis direction.

2. The cutting machine according to claim 1, further comprising a box-shaped table having on a top surface thereof a rectangular work area on which to place the plate,
wherein said X axis and said Y axis run along a long side and a short side of said table, respectively.

3. The cutting machine according to claim 1, wherein weight of a portion of said head movement system that moves in said Y-axis direction is lighter than weight of a portion that moves in said X-axis direction.

4. The cutting machine according to claim 1, wherein said controller, in a case in which multiple products are cut out in succession from the plate on a rectangular work area, controls so that a movement speed when moving said cutting head, without cutting, to a position at which cutting of the products starts or from a position at which cutting of the products ends is faster than a movement speed of said cutting head when carrying out cutting of the products.

5. The cutting machine according to claim 1, wherein said controller adjusts the movement speed of said cutting head according to a thickness and a material of said plate when carrying out cutting, and adjusts said movement speed independently of the thickness and the material of said plate when moving said cutting head without cutting.

6. The cutting machine according to claim 1, wherein said head movement system comprises:
an X-axis moving device that moves in said X-axis direction;
a Y-axis boom mounted on said X-axis moving device so as to move together with said X-axis moving device in said X-axis direction and extending in said Y-axis direction; and
a Y-axis moving device assembled on said Y-axis boom so as to move in said Y-axis direction and mounting said cutting head.

7. The cutting machine according to claim 1, further comprising:
a box-shaped table having on a top surface thereof a rectangular work area on which to place the plate;
a plurality of exhaust chambers aligned in said X-axis direction beneath said work area within said table;
exhaust chamber selection devices that select from said plurality of exhaust chambers one or more exhaust chambers to be exhausted;
means that detects a position in said X-axis direction of said cutting head; and
means that controls said exhaust chamber selection devices so that said one or more exhaust chambers to be exhausted shifts as said cutting head moves in said X-axis direction.

8. The cutting machine according to claim 1, further comprising a human body sensor for detecting a person present within a predetermined spatial range of said cutting head,
wherein said controller stops movement of said cutting head in response to detection of a human body by said human body sensor while moving said cutting head.

9. In a method of moving a cutting head along an X axis and a Y axis of a perpendicular X-Y coordinate system relative to a plate, a cutting head movement method comprising:
a step of moving said cutting head in said X-axis direction without cutting said plate;
a step of moving said cutting head in said Y-axis direction without cutting said plate; and
a step of controlling said cutting head movement so that, when moving said cutting head without cutting said plate, movement speed in said Y-axis direction is faster than movement speed in said X-axis direction.

10. The cutting head movement method according to claim 9, further comprising:
a step of moving said cutting head in said X-axis direction while carrying out cutting of said plate;
a step of moving said cutting head in said Y-axis direction while carrying out cutting of said plate; and
a step of controlling said cutting head movement so that the movement speed of said cutting head when moving said cutting head without carrying out said cutting is faster than the movement speed of said cutting head when moving said cutting head while carrying out said cutting.
